(19) United States
(12) Patent Application Publication
(10) Pub. No.: US 2026/0323807 A1
(43) Pub. Date: Oct. 15, 2026

(54) SYSTEM FOR GENERATING X-RAYS BY LASER-PLASMA ACCELERATION

(71) Applicants: THALES, MEUDON (FR); ECOLE POLYTECHNIQUE, PALAISEAU (FR); CENTRE NATIONAL DE LA RECHERCHE SCIENTIFIQUE, PARIS (FR); ECOLE NATIONALE SUPERIEURE DE TECHNIQUES AVANCEES, PARIS (FR)

(72) Inventors: Cédric THAURY, PALAISEAU (FR); Olena KONONENKO, PALAISEAU (FR); Erwan MOREL, PALAISEAU (FR); Jonathan WHEELER, PALAISEAU (FR); Henri KRAFT, Vélizy-Villacoublay (FR); Jean-Philippe DENIS, Vélizy-Villacoublay (FR); Pascal GIRAULT, Vélizy-Villacoublay (FR); Xuan Quyen DINH, Vélizy-Villacoublay (FR)

(21) Appl. No.: 19/640,264

(22) Filed: Apr. 6, 2026

(30) Foreign Application Priority Data
Apr. 10, 2025 (FR) FR2503843

(51) Int. Cl. H05G 2/00

(52) U.S. Cl. CPC H05G 2/003

(57) ABSTRACT

A system for generating X-rays, includes a source of a laser beam, the laser beam being focused on a gaseous target and generating, by laser-plasma acceleration, an electron beam and a laser beam; a solid bremsstrahlung target configured to be exposed, via its exposed face, to the laser beam and electron beam exiting the gaseous target and to generate X-rays; wherein the solid target comprises a solid protective layer, placed on the exposed face, of density lower than a first threshold (S1), of melting point higher than a second threshold (S2), of thickness lower than a third threshold (S3), and of polished exposed surface of roughness measured by a roughness tester lower than a fourth threshold (S4), the first threshold (S1) being 7 g/cm³, the second threshold (S2) being 1000° C, the third threshold (S3) being 2 mm, and the fourth threshold (S4) being 10 µm.

### CROSS-REFERENCE TO RELATED APPLICATION

This application claims priority to foreign French patent application No. FR 2503843, filed on Apr. 10, 2025, the disclosure of which is incorporated by reference in its entirety.

### FIELD OF THE INVENTION

The invention relates to a system for generating X-rays by laser-plasma acceleration.

### BACKGROUND

Ultra-short laser pulses of pulse width of the order of one femtosecond (10⁻¹⁵ s), for example generated by a femtosecond laser, which is a particular type of laser that produces ultra-short pulses, have noteworthy capabilities in respect of laser/matter interaction, in particular in the context of generation of electrons by laser-plasma acceleration (abbreviated LPA).

These electrons bombard a solid target, sometimes called a converter, to generate X-rays by bremsstrahlung.

Bremsstrahlung (a German word meaning "braking radiation") is a type of electromagnetic radiation emitted when a charged particle (such as an electron) is decelerated or deflected by an electromagnetic field, generally that of an atomic nucleus.

When a fast electron passes near a nucleus, it undergoes a sharp acceleration (or deceleration) due to interaction with the electric field of the nucleus. This variation in velocity results in the emission of an X-ray or gamma-ray photon, depending on the energy involved.

For specific industrial applications, such as low-energy electron beams, the converter must be placed near the electron source and this increases the risk of ablation of the solid converter.

The combination of the laser and electron beams generated following LPA causes much ablation and damage when it interacts with a solid bremsstrahlung target. When exposed to photonic particle beams and an intense laser, the solid target degrades rapidly and its thickness continuously decreases.

Furthermore, when it strikes the surface of the solid target, the laser evaporates the surface of the target, resulting in distribution of particles over the target region. These particles may then deposit on the surface of the optical elements of the device, this degrading the line of transport of the laser beam and therefore the performance of the LPA.

Consequently, the lifetime of an X-ray converter, or solid target, and of optical elements in the target region of the LPA device, becomes insufficient for real-life applications.

It is known to equip LPA systems with a motorized device to ensure either a solid target or optical device is regularly replenished, but this involves complex and expensive technical apparatus.

There is no known solution for preventing degradation of solid bremsstrahlung targets, which would simultaneously decrease pollution of the laser optics near the region occupied by the solid target. Individual protection of each component of the laser system remains possible, but requires a very thin membrane of optical quality to be used and regularly replenished in order to avoid a decrease in laser transmission as a result of damage to the protective membrane, something that would have a very high cost and require a very high level of maintenance.

### SUMMARY OF THE INVENTION

One object of the invention is to overcome the aforementioned problems, and particularly to provide a system for generating X-rays by bremsstrahlung that drastically limits wear of the solid target and the particles due to this wear, at low cost.

According to one aspect of the invention, a system for generating X-rays is provided, the system comprising:
a source of a laser beam, the laser beam being focused on a gaseous target and generating, by laser-plasma acceleration, an electron beam and a laser beam;
a solid bremsstrahlung target configured to be exposed, via its exposed face, to the laser beam and electron beam exiting the gaseous target and to generate X-rays;
wherein the solid target comprises a solid protective layer, placed on the exposed face, of density lower than a first threshold, of melting point higher than a second threshold, of thickness lower than a third threshold, and of polished exposed surface of roughness lower than a fourth threshold, the first threshold being 7 g/cm³, the second threshold being 1000° C, the third threshold being 2 mm, and the fourth threshold being 10 µm.

Such a solid protective layer is transparent to the electron beam and opaque to the photons of the laser beam. What transparent to the electron beam means is that the properties of the electron beam are not significantly modified.

Roughness is a measure of the irregularity of or of the asperities in a surface at a microscopic or macroscopic scale. It characterizes variations in height present on a surface and may influence properties such as friction, adhesion, or wear resistance.

Roughness may be defined by parameters such as average roughness, the maximum height of asperities, or even the standard deviation of such heights. It is often measured using surface profiles obtained by roughness testers.

In one embodiment, the solid protective layer comprises glass.

According to one embodiment, the solid protective layer comprises ceramic.

In one embodiment, the ceramic comprises mica and borosilicate glass, and/or aluminium oxide, and/or zirconium oxide.

According to one embodiment, the solid target comprises copper, and/or titanium, and/or iron, and/or aluminium.

In one embodiment, the solid target includes a downstream layer configured to dissipate heat generated on the solid target.

### BRIEF DESCRIPTION OF THE DRAWINGS

The invention will be better understood on studying a few embodiments that are described by way of completely non-limiting examples and illustrated by the appended drawing, in which:

FIG. 1 schematically illustrates a system for generating X-rays according to one aspect of the invention.

### DETAILED DESCRIPTION

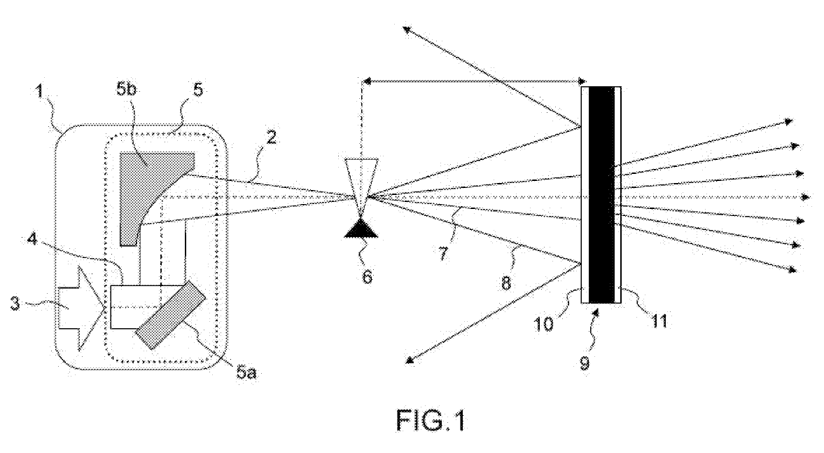

As illustrated in FIG. 1, the system for generating X-rays comprises a source 1 of a laser beam 2, which source comprises a device 3 for delivering an intense laser pulse 4 and an optical device 5 configured to focus the laser beam 2 onto a gaseous target 6, generating, by laser-plasma acceleration (LPA), an electron beam 7 and a laser beam 8.

The system for generating X-rays comprises a solid bremsstrahlung target 9 configured to be exposed, via its exposed face, to the laser beam 8 and electron beam 7 exiting the gaseous target 6 and to generate X-rays.

The solid target 9 comprises a solid protective layer 10 placed on the exposed face, and configured to be transparent to the electron beam 7 and opaque to the photons of the laser beam 8.

Using a solid protective layer 10 in front of the solid target 9 makes it possible to completely or partially reflect or scatter the intense laser following the laser-plasma acceleration and thus reduce the damage caused to the material of the solid target 9, without significantly modifying the properties of the electron beam 7 issuing from the gaseous target 6.

The solid protective layer 10 makes it possible to backscatter most of the laser beam 8 and to transmit most of the electron beam 7.

Thus, the target is degraded much less quickly and the optics of the system is degraded much less rapidly by particles due to abrasion of the solid target 9.

For example, the optical device 5 comprises a plane mirror 5a and an off-axis parabolic mirror 5b, thus allowing the intense laser pulse 4 to be focused on the gaseous target 6.

The solid protective layer 10 may have a density lower than a first threshold S1, for example equal to 7 g/cm³, and may have a melting point higher than a second threshold S2, for example equal to 1000° C.

Preferably, the density is between 4 g/cm³ and 7 g/cm³.

The solid protective layer 10 may have a thickness lower than a third threshold S3, for example equal to 2 mm.

The solid protective layer 10 may have a polished, exposed surface of roughness lower than a fourth threshold S4, for example equal to 10 µm.

The solid protective layer 10 may comprise glass and/or ceramic.

The ceramic may comprise mica and borosilicate glass, for example Macor (registered trademark), and/or aluminium oxide, and/or zirconium oxide.

The solid target 10 may comprise copper, and/or titanium, and/or iron, and/or aluminium.

The solid target 10 may comprise a downstream layer 11 configured to dissipate heat generated on the solid target 9.

The present invention makes it possible to obtain a system for generating X-rays equipped with a solid multilayer target 9 a solid protective first layer 10 of which is transparent to the electron beam 7 but resistant to the laser beam 8, and a second layer of which converts the energy of the electrons into X-rays, and that may comprise a third layer 11 for dissipating heat generated on the solid target 9.

By way of completely non-limiting example, a Ti:sapphire laser source 1 (a titanium-sapphire laser being a type of solid-state laser that uses a sapphire crystal doped with titanium (Ti³⁺) as gain medium) of 10 TW with a pulse duration of 45 fs used to generate an electron beam 7 by LPA by means of a gas target 6, which beam is then converted into a secondary X-ray beam using a solid tungsten target 9.

The laser beam 2 may be focused on a gas jet or gaseous target 6 by an off-axis, F/6 (focal length 6 times the diameter of the mirror) parabolic mirror 5b with a focal length of 254 mm.

The focal spot of the laser has a full width at half maximum (FWHM) of 5-6 microns in the transverse direction and is located at the entrance of a gas plume or gas column of 2 mm length. The laser beam 2 ionizes the nitrogen, thus generating a plasma the density of which is between 10¹⁸ and 10²⁰ electrons/cm³, then the central part of the laser beam, the intensity of which is highest, ionizes the remaining electrons in the acceleration cavity. Inside this cavity, electrons gain as much as 100 MeV of energy via the wake field, ponderomotive acceleration or direct laser acceleration.

In order to produce the X-rays, a solid target 9 made of a conversion material of high atomic number Z, such as tungsten or tantalum, for example of a thickness of 0.5 to 1 mm, is placed on the laser/electron axis 5 mm after the gas target 6.

An intense laser, reaching the surface of the converter or solid target 9, may ionize the front face evaporating part of the material. The electron beam propagates through the converter, generating an X-ray beam the size of which corresponds to the size of the electron beam inside the solid target 9 and the maximum energy of which corresponds to the maximum energy of the electrons.

In the case of tomography in particular, thousands of shots are required, which means that, under normal conditions, solid X-ray targets are rapidly destroyed and must be frequently replaced. Furthermore, the evaporated metal particles may deposit on the surface of the optics. Such contamination decreases the transmission from the laser to the gas target 6 until the complete LPA becomes impossible.

In order to protect the solid bremsstrahlung target 9, various protective layers, including glass, diamond, zirconium, Macor (registered trademark), alumina and sapphire, of a thickness for example from 0.1 to 0.5 mm, have all achieved the desired result. The level of contamination has been suppressed, and hence the elements of the optical device 5 no longer need to be replaced.

The protective layer 10 is however more resistant to ablation by the laser beam 8. The protective layer 10, although more resistant to laser ablation, still needs to be replaced from time to time, but it allows up to two orders of magnitude (i.e. hundreds of times more) of additional shots to be fired at the same location, thus protecting the converter or solid target 9 from any damage.

In the case of applications to scanners, the distance between the gaseous target 6 that is the source of the electron beam 7 and the solid target 9 must be less than 1 cm, for electrons of energy of less than 10 MeV, because of problems with divergence of the beam of electrons produced by the laser-plasma acceleration. These problems with divergence do not exist at higher energies.

The present invention makes it possible to prevent rapid wear of the solid target and, when a compact X-ray generating system is used, to prevent ablation particles that damage optical elements.

1. A system for generating X-rays, comprising:
a source of a laser beam, the laser beam being focused on a gaseous target and generating, by laser-plasma acceleration, an electron beam and a laser beam;
a solid bremsstrahlung target configured to be exposed, via its exposed face, to the laser beam and electron beam exiting the gaseous target and to generate X-rays;
wherein the solid target comprises a solid protective layer, placed on the exposed face, of density lower than a first threshold (S1), of melting point higher than a second threshold (S2), of thickness lower than a third threshold (S3), and of polished exposed surface of roughness measured by a roughness tester lower than a fourth threshold (S4), the first threshold (S1) being 7 g/cm³ the second threshold (S2) being 1000 °C, the third threshold (S3) being 2 mm, and the fourth threshold (S4) being 10 µm.

2. The system for generating X-rays according to claim 1, wherein the solid protective layer comprises glass.

3. The system for generating X-rays according to claim 1, wherein the solid protective layer comprises ceramic.

4. The system for generating X-rays according to claim 3, wherein the ceramic comprises mica and borosilicate glass, and/or aluminium oxide, and/or zirconium oxide.

5. The system for generating X-rays according to claim 1, wherein the solid target comprises copper, and/or titanium, and/or iron, and/or aluminium.

6. The system for generating X-rays according to claim 1, wherein the solid target comprises a downstream layer configured to dissipate heat generated on the solid target.
